(19) United States
(12) Patent Application Publication
(10) Pub. No.: US 2014/0272539 A1
(43) Pub. Date: Sep. 18, 2014

(54) BATTERIES

(71) Applicants: Chau Sing Ip, Huizhou City (CN); Kwai Sang Lai, Tuen Mun (HK); Cun Liang Zhang, Huizhou (CN)

(72) Inventors: Chau Sing Ip, Huizhou City (CN); Kwai Sang Lai, Tuen Mun (HK); Cun Liang Zhang, Huizhou (CN)

(73) Assignee: GP BATTERIES INTERNATIONAL LIMITED, New Territories, Hong Kong (CN)

(21) Appl. No.: 14/349,863

(22) PCT Filed: Oct. 10, 2011
(86) PCT No.: PCT/CN2011/080605

§ 371 Date: Apr. 4, 2014

(51) Int. Cl. H01M 4/62; H01M 2/02

(52) U.S. Cl. CPC H01M 4/624; H01M 2/02; H01M 2/022; H01M 2/024
USPC 429/156; 429/212; 429/164

(57) ABSTRACT

A battery cell comprises a positive electrode, a negative electrode, and a separator which separates the positive and negative electrodes. Specifically, a non-reactive conductive substance is dispersed in a starch layer distributed between an electrode and the separator. The present invention is advantageous for reducing the internal resistance between the electrode and the separator.

### FIELD OF THE INVENTION

The present invention relates to batteries, and more particular to batteries having a paste-like layer intermediate an electrode and a separator. More specifically, although not solely limited thereto, this invention relates to carbon zinc batteries.

### BACKGROUND OF THE INVENTION

A battery may comprise a single battery cell or a plurality of battery cells. Each battery cell includes a battery cell assembly of a positive electrode, a negative electrode, and a separator separating the positive and negative electrodes. The battery cell assembly is held compactly together by a receptacle or a sub-casing and is soaked in an electrolyte which facilitates charging and discharging chemical reactions respectively when the positive and negative electrodes are electrically connected to a charging source or a load.

The positive electrode is typically formed of a positive active substance which is typically an oxidizing agent such as manganese dioxide, nickel oxide, lead dioxide, or the like. The negative electrode is typically formed of a negative active substance such as zinc, nickel, lead, or other negative active compositions. The separator is typically made of an electrolyte-supporting material which can be any kind of material with electrical insulating properties. The electrolyte can be an aqueous acid solution, an alkaline solution, paste-like or a combination whereof. Paste-like electrolyte is used to mitigate migration of solid particles in the battery and can be applied locally on a separator surface or contained in a battery container and surrounding the entire battery cell assembly. A paste-like electrolyte is typically a mixture of a battery electrolyte and a starch composition. The starch composition is usually a mixture of corn starch or flour, such as a modified starch.

### SUMMARY OF THE INVENTION

Accordingly, there is provided a battery cell comprising a positive electrode, a negative electrode, and a separator which separates the positive and negative electrodes; wherein a non-reactive conductive substance is dispersed in a starch layer distributed between an electrode and the separator whereby battery internal resistance between the electrode and the separator is reduced. Dispersion of a conductive substance intermediate the separator and an electrode is advantageous because it decreases internal resistance without introducing adverse reaction.

The non-reactive conductive substance may be a carbon based powder.

The non-reactive conductive substance may comprise carbon black, graphite, ethylene black, or a combination thereof.

The non-reactive conductive substance may include a non-reactive metal powder or a non-reactive metal alloy powder.

A non reactive substance in the present context means a substance which will not react in an electrolyte during battery operations.

In an example, the battery is a carbon zinc battery and the non-reactive conductive substance comprises zinc powder. The carbon zinc battery includes a negative zinc electrode plate, the conductive substance being dispersed in the starch layer intermediate the separator and the zinc electrode plate.

In one example, the conductive substance is dispersed in a non-conductive paste intermediate the separator and the negative electrode.

In one example, the negative electrode is a negative electrode composite comprising a negative electrode plate, an insulator layer, and a conductive paste layer intermediate and joining the negative electrode plate and the insulation layer, the conductive paste layer comprising conductive substances dispersed in a non-conductive paste layer.

The non-conductive starch layer may be disposed intermediate the conductive paste layer and the insulation layer.

In an example, the positive electrode is a positive electrode tablet, the negative electrode is a paper sheet covered negative electrode plate composite, and the separator is a porous insulating cup receiving and surrounding the positive electrode tablet, the conductive substance dispersed paste layer forming part of the negative electrode plate composite and being intermediate the paper sheet and a surface of a negative electrode plate.

The positive electrode tablet may be composed of manganese dioxide, conductive substances and binding agents; and the negative electrode plate is zinc based.

A non-conductive starched layer may be intermediate the conductive paste layer and the paper, the conductive substances in the conductive paste layer being adapted for dispersion into the non-conductive starched layer to modify the non-conductive starched layer into a conductive layer upon addition of electrolyte.

In an example, the battery cell is a cylindrical battery cell comprising an anode can, a cylinder of cathode mix, and a hollow cylindrical separator cup; and wherein the conductive paste layer is distributed between the anode can and the separator cup.

In another aspect, there is provided a multi-cell battery comprising a plurality of battery cells as described herein, wherein the conductive substances are adapted for gradual dispersion into the insulator layer upon adding of an electrolyte.

### BRIEF DESCRIPTION OF DRAWINGS

Embodiments of the present invention will be explained below by way of example and with reference to the accompanying drawings or figures, in which:—

FIG. 1 is a cross-sectional view of a tablet-type battery cell,

FIG. 2A is a partially enlarged view of the negative electrode composite 120 of FIG. 1,

FIG. 2B is another example of a negative electrode composite suitable for use in the tablet cell of FIG. 1,

FIG. 3 is an exploded view showing components of the tablet-type battery cell of FIG. 1,

FIG. 4 is an example of a multi-cell battery assembled from a plurality of battery cells of FIG. 1,

FIG. 5 is a cylindrical battery example illustrating the present invention, and

### DESCRIPTION OF EXEMPLARY EMBODIMENTS

A standard sized tablet battery cell 100 depicted in FIG. 1 comprises a positive electrode 110, a negative electrode 120 and a separator 130 separating the positive and negative electrodes.

The positive electrode 110 is in a tablet form as a positive electrode tablet and comprises a mixture of manganese dioxide powder, carbon powder and binding agents. The manganese dioxide powder (as an example of positive electrode active substance), the carbon powder (as an example of a non-reactive conductive substance) and the binding agents are mixed together and then compressed into a predefined tablet shape, for example, by moulding or stamping. The tablet has a general rectangular block and is of the type suitable for assembly into a standard-sized 9-volt battery as depicted in EP 1,408,565A.

The separator 130 is made of a porous starch coated paper and is formed into the shape of a paper cup for receiving the positive electrode tablet in a closely fitted manner. The paper cup, as an example of an insulating receptacle or an insulating cup, comprises a base portion and peripheral walls surrounding the base portion. The cup is arranged such that the bottom of the positive electrode tables sits on the base portion and the peripheral sides of are surrounded in contact by the cup peripheral walls.

The negative electrode 120 is an electrode plate composite comprising an electrode plate 122 having the same or comparable surface area to a major surface of the positive electrode tablet to get a maximal reaction area. The negative electrode plate is made of Zinc or Zinc alloy and having a top surface proximal the positive electrode tablet and a bottom surface distal from the positive electrode tablet.

As shown in more detail in FIG. 2A, the negative electrode plate 122 (or the Zinc plate) is covered with a piece of base paper 128 with a starch layer 127 applied intermediate the base paper 128 and the negative electrode plate 122. Paper covered zinc plates are usually supplied to protect the active electrode surface which is proximal the positive electrode tablet. A conductive membrane 124 is further pasted on the surface of the Zinc plate distal from the positive electrode tablet for surface protection while maintaining good conductivity. In addition, an additional conductive paste layer 126 comprising a mixture of starch and carbon powder is applied intermediate the Zinc plate and the starch paper. The carbon powder, as an example of non-reactive conductive substances, is dispersed throughout the paste layer to increase conductivity of the paste layer. Flour or modified starch is a substance commonly used starch compositions in batteries to mitigate migration of solid particles in the battery.

FIG. 2B shows a second example of a negative electrode composite 220 suitable for assembly into a battery tablet cell of FIG. 1. This negative electrode composite comprises a zinc plate 222 as an example of a negative electrode plate, a piece of base paper 228 covering one surface of the zinc plate, a conductive paste layer 226 intermediate the base paper and the zinc plate, and a conductive membrane 224 covering the other surface of the zinc plate 222. This negative electrode composite 220 is identical to the negative electrode composite 220 except that there is only one single conductive starch layer intermediate the zinc plate 222 and the base paper 228. This conductive starch layer comprises a mixture of modified starch and dispersed carbon powder. As the negative electrode composite 220 is substantially identical to that of negative electrode composite 120, parts of the negative electrode composite 220 which are common or equivalent to that of negative electrode composite 120 are referred to using the same numerals plus 100. FIG. 3 shows a process of assembling components of the battery cell tablet into a plastic cup.

The components of the battery cell assembly comprising the positive electrode tablet 110, the negative electrode composite 120, and the separator 130 are bound tightly together by a plastic wrap 150 to form a battery cell tablet 100. The plastic wrap, for example made of a plastic cup of polyvinyl chloride (PVC), forms an insulating cell holder which exposes a positive electrode contact surface and a negative electrode contact surface for external or inter-cell contacts.

The plastic cup includes a peripheral wall which defines an axial bore having an upper aperture and a lower aperture. The upper aperture is adapted to allow entry of the negative electrode plate with the major active surfaces of the negative electrode plate orthogonal to the bore axis. The lower aperture is shaped and sized to retain and restrain the negative electrode plate while leaving a negative electrode plate contact aperture. The negative electrode plate composite of FIG. 2 is inserted into the plastic cup with its major surfaces orthogonal or substantially to the bore axis. A positive electrode sub-assembly comprising the positive electrode tablet and the paper cup insulator is then inserted into the plastic cup and above the negative electrode plate composite. The positive electrode sub-assembly is formed by placing the positive electrode tablet into the positive electrode cup such that the bottom surface of the positive electrode tablet is in contact with the bottom portion of the paper cup and its peripheral walls are surrounded by the peripheral walls of the paper cup. When the sub-assembly is inserted into the plastic cup, the peripheral walls of the paper cup are pushed by the peripheral walls of the plastic cup towards the peripheral walls of the positive electrode tablet such that the peripheral walls of the paper cup are pressed against the peripheral walls of the positive electrode tablet.

After the negative electrode plate composite and the positive electrode tablet sub-assembly have been inserted into the plastic cup and urged together, the plastic cup is permanently deformed into a plastic wrap to hold the components tightly and closely together.

To form a multi-cell battery, a plurality of the tablet battery cells is inserted into a metallic battery can as shown in FIG. 4. The battery 300 of FIG. 4 is a standard sized 9-volt battery as an example of a multi-cell battery. The battery can 340 is filled with an electrolyte after the plurality of tablet battery cells has been inserted and positive and negative 320 battery terminals are then formed to complete battery assembly. After electrolyte has been filled inside the can and soaking the battery tablets cells, the starch on the starched paper will gradually develop into a paste or gel-like layer upon absorption of the electrolyte. At the same time, the mobility of the conductive substances in the paste layer also gradually increases due to further moistening of the paste-like material until equilibrium. As a result, the conductive substances will disperse into the paste-like layer of the starched paper, thereby increasing the conductivity in the space between the positive electrode tablet and the negative electrode plate. As the resistance in the space between the positive electrode tablet and the negative electrode plate is determinative of the internal resistance of a battery, it is noted that the battery internal resistance is notably reduced and performance efficiency is increased.

An anode plate composite comprising a starch paper covered zinc plate with a conductive paste layer intermediate the zinc plate and the starched paper is because commonly available zinc plate for battery application is traditionally covered with a starch coated paper, and the application of such a conductive paste layer means minimal alteration of conventional battery zinc plates.

In an alternative example, the anode plate composite of FIG. 2, and hence the battery tablet cell, is modified by eliminating the non-conductive starch layer such that only a starch paste layer dispersed with conductive substances is disposed intermediate the anode plate. The elimination of the non-conductive starch layer means internal resistance of the battery is already greatly enhanced when an electrolyte is filled, thereby shortening the time to reach optimal conductivity.

The cylindrical battery 400 of FIG. 5 is an example of a single cell battery incorporating a conductive starch layer of the present invention. The example cylindrical battery is a manganese zinc battery comprising a carbon rod electrode as a current collector. The carbon rod is surrounded by a cylinder of positive electrode mix (or cathode mix) of manganese dioxide, carbon powder and binding agents. The cylinder of positive electrode mix is contained within or surrounded by an anode can having a closed bottom and an open top. The anode can is hollow cylindrical and is made of zinc or zinc alloy in this manganese zinc battery. An insulating separator paper cup 430 having an open end and a closed bottom portion is disposed intermediate the positive electrode mix and the anode can as a separator between the positive and negative electrodes. The closed bottom portion of the insulating separator paper cup is circular or substantially circular which is surrounded by an upstanding peripheral wall. The upstanding peripheral is adapted such that when the positive electrode mix is received within the separator paper cup with the cylinder of positive electrode mix sitting on the circular bottom portion, the height of the peripheral wall of the insulating cups is at least equal to or higher than that of the cylindrical wall of the positive electrode mix to provide adequate separation between the electrodes. To increase inter-electrode conductivity, a conductive paste layer 426 of starch dispersed with carbon powder as an example of non-reactive conductive substances is disposed intermediate the separator cup and the anode metallic can. It is noted that dispersion of carbon powder in the intermediate starch layer increases conductivity, and hence decreases battery internal resistance, without adverse reaction. The open top of the closed anode can is covered with a metal top which is in electrical connection with the positive electrode mix to form a positive electrode 410 contact terminal, while the closed anode can bottom serves as a negative contact terminal 422.

In this example, the conductive paste layer is distributed in the space intermediate the insulating paper cup and the hollow cylindrical anode can. The anode can is not an anode having a starch coated base paper 428 on its internal cylindrical surface.

While embodiment(s) of the present invention(s) has/have been explained with reference to the examples above, the embodiments are non-limiting examples for illustrating the present invention(s) and should not be construed to limit the scope of the invention. For example, while an embodiment has been explained with reference to a carbon zinc, it should be appreciated that the invention is applicable to other batteries having a paste like layer between battery electrodes without loss of generality.

In general, the conductive substances which is suitable for dispersion in the paste or starch layer to enhance conductive would be one that is non reactive with respect to the anode material. Suitable conductive substances for this application include, for example, acetylene black, graphite, carbon black, nickel powder, and the like. Binding agents which are suitable to be added to the positive electrode composition to improve the binding integrity or strength of the positive active material, include, for example, carboxymethylcellulose, polytetrafluoroethylene, salts of carboxymethylcellulose, polyvinyl alcohol, polyethylene, agar, methylcellulose, and the like. Furthermore, while paper is commonly used as a separator material, it will be appreciated that other porous insulating materials such as polymers can also be used.

Table of Numerals

| | | | | |
|---|---|---|---|---|
| 100 | 200 | 300 | 400 | Battery cell |
| 110 | | | 410 | Positive electrode |
| 120 | 220 | 320 | | Negative electrode |
| 122 | 222 | | 422 | Negative electrode plate |
| 124 | 224 | | | Conductive membrane |
| 126 | 226 | | 426 | Paste layer |
| 127 | | | | Starch layer |
| 128 | 228 | | 428 | Base paper |
| 130 | | | 430 | Separator |
| | | 340 | | Battery can |
| 150 | | | | Plastic wrap |

1. A battery cell comprising a positive electrode, a negative electrode, and a separator which separates the positive and negative electrodes; wherein a non-reactive conductive substance is dispersed in a starch layer distributed between an electrode and the separator whereby battery internal resistance between the electrode and the separator is reduced.

2. A battery cell according to claim 1, wherein the non-reactive conductive substance is carbon based powder.

3. A battery cell according to claim 1, wherein the non-reactive conductive substance comprises carbon black, graphite, ethylene black, or a combination thereof.

4. A battery cell according to claim 1, wherein the non-reactive conductive substance includes a metal powder or a metal alloy powder.

5. A battery cell according to claim 1, wherein the battery is a carbon zinc battery and the non-reactive conductive substance comprises zinc powder.

6. A battery cell according to claim 1, wherein the conductive substance is dispersed intermediate the separator and the negative electrode.

7. A battery cell according to claim 6, wherein the battery is a carbon zinc battery having a negative zinc electrode plate, the conductive substance being dispersed in the starch layer intermediate the separator and the zinc electrode plate.

8. A battery cell according to claim 1, wherein the negative electrode is a negative electrode composite comprising a negative electrode plate, an insulator layer, and a conductive paste layer intermediate and joining the negative electrode plate and the insulation layer, the conductive paste layer comprising conductive substances dispersed in a non-conductive paste layer.

9. A battery cell according to claim 8, wherein a non-conductive starch layer is disposed intermediate the conductive paste layer and the insulation layer.

10. A battery cell according to claim 1, wherein the positive electrode is a positive electrode tablet, the negative electrode is a paper sheet covered negative electrode plate composite, and the separator is a porous insulating cup receiving and surrounding the positive electrode tablet, the conductive substance dispersed paste layer forming part of the negative electrode plate composite and being intermediate the paper sheet and a surface of a negative electrode plate.

11. A battery cell according to claim 10, wherein the positive electrode tablet is composed of manganese dioxide, conductive substances and binding agents; and the negative electrode plate is zinc based.

12. A battery cell according to claim 10, wherein the a non-conductive starched layer is intermediate the conductive paste layer and the paper, the conductive substances in the conductive paste layer being adapted for dispersion into the non-conductive starched layer to modify the non-conductive starched layer into a conductive layer upon addition of electrolyte.

13. A battery cell according to claim 1, wherein the battery cell is a cylindrical battery cell comprising a anode can, a cylinder of cathode mix, and a hollow cylindrical separator cup; and wherein the conductive paste layer is distributed between the anode can and the separator cup.

14. A multi-cell battery comprising a plurality of battery cells, wherein each battery cell comprises a positive electrode, a negative electrode, and a separator which separates the positive and negative electrodes; wherein a non-reactive conductive substance is dispersed in a starch layer distributed between an electrode and the separator whereby battery internal resistance between the electrode and the separator is reduced, and wherein the conductive substances are adapted for gradual dispersion into the insulator layer upon adding of an electrolyte.

15. A multi-cell battery according to claim 14, wherein the non-reactive conductive substance is carbon based powder.

16. A multi-cell battery according to claim 14, wherein the non-reactive conductive substance includes a metal powder or a metal alloy powder.

17. A multi-cell battery according to claim 14, wherein the battery is a carbon zinc battery and the non-reactive conductive substance comprises zinc powder.

18. A multi-cell battery according to claim 14, wherein the conductive substance is dispersed intermediate the separator and the negative electrode.

19. A multi-cell battery according to claim 18, wherein the battery is a carbon zinc battery having a negative zinc electrode plate, the conductive substance being dispersed in the starch layer intermediate the separator and the zinc electrode plate.

20. A multi-cell battery according to claim 14, wherein the negative electrode is a negative electrode composite comprising a negative electrode plate, an insulator layer, and a conductive paste layer intermediate and joining the negative electrode plate and the insulation layer, the conductive paste layer comprising conductive substances dispersed in a non-conductive paste layer.

21. A battery cell according to claim 8, wherein a non-conductive starch layer is disposed intermediate the conductive paste layer and the insulation layer.

22. A battery cell according to claim 1, wherein the positive electrode is a positive electrode tablet, the negative electrode is a paper sheet covered negative electrode plate composite, and the separator is a porous insulating cup receiving and surrounding the positive electrode tablet, the conductive substance dispersed paste layer forming part of the negative electrode plate composite and being intermediate the paper sheet and a surface of a negative electrode plate.

23. A battery cell according to claim 10, wherein the positive electrode tablet is composed of manganese dioxide, conductive substances and binding agents; and the negative electrode plate is zinc based.

24. A battery cell according to claim 10, wherein the a non-conductive starched layer is intermediate the conductive paste layer and the paper, the conductive substances in the conductive paste layer being adapted for dispersion into the non-conductive starched layer to modify the non-conductive starched layer into a conductive layer upon addition of electrolyte.

25. A battery cell according to claim 1, wherein the battery cell is a cylindrical battery cell comprising a anode can, a cylinder of cathode mix, and a hollow cylindrical separator cup; and wherein the conductive paste layer is distributed between the anode can and the separator cup.
